(19) United States
(12) Patent Application Publication
(10) Pub. No.: US 2007/0001443 A1
(43) Pub. Date: Jan. 4, 2007

(54) Seat belt retractor and seat belt device

(75) Inventor: Eiji Yanagi, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/472,408

(22) Filed: Jun. 22, 2006

(30) Foreign Application Priority Data
Jun. 30, 2005 (JP) 2005-190973
Feb. 27, 2006 (JP) 2006-050419

(51) Int. Cl. B60R 22/46; B65H 75/48

(52) U.S. Cl. 280/806; 280/807; 242/390.8

(57) ABSTRACT

The disclosed seat belt retractor and seat belt device improve the reliability of a belt withdrawn amount sensing unit for detecting the withdrawn amount of a belt with a high accuracy. The seat belt retract may comprise a spool for withdrawably retracting a seat belt and a rotation angle detecting unit for detecting a rotation angle of the spool. The rotation angle detecting unit can be a belt withdrawn amount sensing unit for detecting a predetermined rotation angle of the spool in a belt withdrawn direction. The belt withdrawn amount sensing unit can comprise a Hall switch which includes a magnet for moving according to a predetermined rotation amount of the spool in the seat belt withdrawn direction of the spool and a Hall element which is controlled to be turned on or off by the magnet.

### BACKGROUND

The present invention relates to a seat belt retractor for withdrawably retracting a seat belt, and more particularly, to a seat belt retractor having a belt fastening sensing unit for detecting the withdrawn amount of a seat belt to sense a seat belt fastened state of an occupant and a seat belt device having the seat belt retractor.

A conventional seat belt device installed in a vehicle, such as a car, restrains an occupant with a seat belt at a time of an emergency, such as a car collision, where a large deceleration is exerted on the vehicle so as to prevent the occupant from being thrown out from the seat. The seat belt device is provided with a seat belt retractor for retracting the seat belt. In the seat belt retractor, the seat belt is retracted onto a spool when the seat belt is not fastened, and the seat belt is withdrawn and fastened to the occupant when the seat belt is fastened. At the time of an emergency, a lock member of the seat belt retractor operates to stop a rotation of the spool in a belt withdrawn direction thereof so that the withdrawal of the seat belt is prevented. By doing so, the seat belt can securely restrain and protect the occupant.

In order to securely restrain the occupant at the time of an emergency, the fastening of the seat belt needs to be securely performed by the occupant. For this reason, the conventional seat belt device is provided with a seat belt fastening sensing unit. A seat belt device having such a seat belt fastening sensing unit has been proposed (see Japanese Examined Patent Application Publication No. 3-70655, hereinafter referred to as the '655 reference). The seat belt device includes a seat belt fastening sensing unit for sensing the fastening of the seat belt by using a buckle switch embedded in the buckle, which is turned on when the tongue is engaged with the buckle and is turned off when the tongue is released from the buckle.

According to the seat belt device disclosed in the '655 reference, when the occupant withdraws the seat belt from the seat belt retractor and engages the tongue with the buckle, the buckle switch turns on so that the fastening of the seat belt by the occupant is sensed.

On the other hand, various layouts of vehicle seats have been provided to newer vehicles. Particularly, vehicles have been developed in which the vehicle seat is detachable from the chassis. In a case where the fastening sensing unit disclosed in the '655 reference is applied to such a vehicle seat for obtaining information of the occupant's fastening of the seat belt, a connection unit is needed in the chassis between the buckle and the chassis to connect and disconnect the wire harness that electrically connects the buckle switch with the CPU disposed in the chassis because the buckle is generally attached to the vehicle seat.

Therefore, a seat belt device has been proposed which has a mechanical seat belt retracted amount sensing switch as well as the buckle switch embedded in the buckle. The mechanical seat belt retracted amount sensing switch senses a retracted amount of a belt retracted onto the spool of the seat belt retractor, thereby sensing the occupant's fastening of the seat belt. (See Japanese Unexamined Patent Application Publication No. 9-82171, hereafter referred to as the '171 reference).

In the seat belt device disclosed in the '171 reference, the seat belt retracted amount sensing switch includes a movable member. The movable member is always in contact with a circumferential surface of the seat belt retracted onto the spool of the seat belt retractor and is displaced depending on the variation in the diameter of the retracted belt according to the retracted amount of the seat belt. The seat belt retracted amount sensing switch has a sliding contact point and a fixed contact point in which the fixed contact point contacts the sliding contact point when the movable member is displaced by a predetermined amount. In addition, when the sliding contact point is in contact or non-contact with the fixed contact point, the seat belt retracted amount sensing switch is in the ON or OFF state such that it is sensed whether or not the seat belt is retracted by a predetermined amount.

Because the seat belt retracted amount sensing switch is attached to the seat belt retractor fixed to the chassis, even in a case where it is applied to the aforementioned vehicle in which the vehicle seat is detachable from the chassis, there is no need for a connection unit for a wire harness between the buckle and the chassis.

However, in the sensing of a retracted amount of a seat belt based on the variation in the diameter of the retracted belt, the diameter of the retracted belt varies according to a seat belt retracted state on the spool irrespective of the retracted amount of the seat belt. Thus, there is a problem in that the determination of the turning on and off of the seat belt retracted amount sensing switch cannot be obtained with good accuracy. In addition, in such a mechanical switch, there is a problem in that it is difficult to determine whether or not the contact point of the switch is in a normal state.

On the other hand, the seat belt device disclosed in the '655 reference is provided with a rotation angle detecting ratchet wheel and a displacement detecting device. The rotation angle detecting ratchet wheel is integrally fixed to a retracting shaft so as to rotate therewith. The displacement detecting device detects a rotation displacement of the rotation angle detecting ratchet wheel by using two photo couplers. In this seat belt device, a CPU counts the pulse signals for the optical detection of the rotation displacement transmitted from the two photo couplers to sense a rotation direction and a rotation angle of the retracting shaft so that the retracted amount of the seat belt, i.e., a belt retracted amount, can be sensed. Because there is no contact point in such an optical detection of the retracted amount of the seat belt, the aforementioned problems of the mechanical switch having the contact point do not occur.

However, in the non-contact optical sensing of the retracted amount of the seat belt disclosed in the '655 reference, when the photo coupler is stained with contaminants after being used for a long time, the amount of light of the photo coupler is lowered due to these contaminants. As a result, there is a problem in that it is difficult to sense the retracted amount of the seat belt with a high accuracy, and the reliability of the optical belt retracted amount sensing unit is lowered.

In addition, because any signal cannot flow in the OFF state in the aforementioned sensing of the retracted amount of the seat belt using the mechanical switch and the aforementioned optical sensing of the retracted amount of the seat belt using the photo coupler, disconnection of the wire harness or the like cannot be detected in the OFF state. Thus, the reliability of the sensing of the retracted amount of the seat belt can be lowered. Therefore, resistors are disposed parallel to the contact points of the switch or the photo coupler so that a current is allowed to flow by bypassing the contact points of the switch or the photo coupler in the OFF state thereof in order to detect the disconnection in the OFF state, thereby improving a reliability of the sensing of the retracted amount of the seat belt. However, in the case where the resistors are inserted, although the disconnection can be detected, the contact point of the switch or the photo coupler cannot be diagnosed, and the reliability of the sensing of the retracted amount of the seat belt cannot be securely and sufficiently improved. In addition, when the resistors are used, the number of parts increases so that there is a problem of increasing costs.

The present disclosure is contemplated in consideration of the aforementioned problems, and an object of the present application is to provide a seat belt retractor capable of improving the reliability of a belt withdrawn amount sensing unit for detecting the withdrawn amount of the seat belt with a high accuracy, more securely sensing a fastening of a seat belt, and suppressing an increase in the number of parts. Another object is to provide a seat belt device having the seat belt retractor.

### SUMMARY

According to one embodiment of the present invention, a seat belt retractor can comprise at least a spool for withdrawably retracting a seat belt and a rotation angle detecting unit for detecting a rotation angle of the spool. The rotation angle detecting unit can be a belt withdrawn amount sensing unit for sensing a predetermined withdrawn amount of a seat belt by detecting a predetermined rotation angle of the spool in a belt withdrawn direction with reference to an entire retracted state of the spool at a time when the seat belt is not fastened. The belt withdrawn amount sensing unit can comprise a Hall switch which includes a magnet for moving according to a predetermined rotation amount of the spool in the belt withdrawn direction of the spool and a Hall element which is controlled to be turned on or off by the magnet.

In addition, a seat belt retractor can comprise a switch lever in which one end portion is swingably supported by a frame which rotatably supports the spool or is supported by a fixing member to which the frame is fixed. The magnet can be attached to the other end portion of the switch lever The switch lever may be formed to rotate with the spool and controlled to swing by a rotation angle detecting cam wheel having a convex cam on a circumference thereof so that, when the spool is in the entirely retracted state, the switch lever allows the magnet to be largely separated from the Hall element to turn off the Hall switch. At a time when the seat belt is withdrawn by a predetermined withdrawn amount with reference to the entire retracted state of the spool, the convex cam allows the switch lever to operate and the magnet to approach closely to the Hall element to turn on the Hall switch.

Furthermore, a seat belt retractor can comprise a switch lever in which one end portion is swingably supported by a frame which rotatably supports the spool or is supported by a fixing member to which the frame is fixed. The magnet may be attached to the other end portion of the switch lever. The switch lever may be formed to rotate with the spool and controlled to swing by a rotation angle detecting cam wheel having a concave cam on a circumference thereof, so that, when the spool is in the entire retracted state, the switch lever allows the magnet to approach closely to the Hall element to turn off the Hall switch. At a time when the seat belt is withdrawn by a predetermined withdrawn amount with reference to the entire retracted state of the spool, the concave cam allows the switch lever to operate and the magnet to be largely separated from the Hall element to turn on the Hall switch.

A seat belt device can comprises at least: a seat belt retractor for retracting a seat belt; a tongue which is slidably supported by the seat belt withdrawn from the seat belt retractor; and a buckle for releaseably engaging with the tongue. The withdrawal of the seat belt can be prevented by the seat belt retractor at a time of an emergency, thereby restraining an occupant. The seat belt retractor can be the seat belt retractor according to any one of the disclosed embodiments.

In the seat belt retractor having such a construction according to the present invention and the seat belt device having the seat belt retractor, it is possible to suppress the influence of the contaminants on the detection of the rotation angle of the spool because the Hall switch is used for the rotation angle detecting unit constituting the belt withdrawn amount sensing unit. Therefore, in a long term use, the rotation angle of the spool can be sensed with a high accuracy, and the reliability of the rotation angle detecting unit can be improved. In addition, because the rotation angle detecting unit is used as a belt withdrawn amount detecting unit, it is possible to more securely detect the fastening of the seat belt by the occupant.

Because the Hall switch can allow a small current to flow in the OFF state thereof, the small current is set so as to flow in the OFF state thereof and a relatively large current is set so as to flow in the ON state thereof so that it is possible to securely sense the withdrawn amount of the seat belt and securely detect the disconnection in the OFF state thereof. By doing so, the reliability of the sensing of the withdrawn amount of the seat belt can be further improved. In addition, because there is no need to use resistors unlike the aforementioned conventional case, it is possible to suppress the increase in the number of parts; thus reducing costs.

In addition, because the rotation angle detecting unit is attached to the seat belt retractor fixed to the chassis, even in a case where it is applied to the aforementioned vehicle in which the vehicle seat is detachable from the chassis, there is no need for a connection unit for the wire harness between the buckle and the chassis.

It is to be understood that both the foregoing general description and the following detailed description are exemplary and explanatory only, and are not restrictive of the invention as claimed

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a cross-sectional view showing a portion of a seat belt retractor according to an embodiment of the present invention.

FIG. 2 is a schematic view showing a rotation angle detecting cam wheel and a switch lever in a rotation angle detecting unit according to the embodiment shown in FIG. 1.

FIG. 3 is a cross-sectional view showing the operation of a Hall switch, that is, a rotation angle detecting unit according to the embodiment shown in FIG. 1.

FIG. 3(a) is a view showing an OFF state of the Hall switch and FIG. 3(b) is a view showing an ON state of the Hall switch.

FIG. 4 is a view showing a Hall element and a wiring circuit in the Hall switch according to the embodiment shown in FIG. 1.

FIG. 5 is a perspective view showing an embodiment of a seat belt device in which the seat belt retractor according to the embodiment shown in FIG. 1 is applied.

FIG. 6 is a cross-sectional view of a seat belt retractor according to another embodiment of the present invention. FIG. 6(a) is a view showing an OFF state of the Hall switch similar to that of FIG. 3(a) and FIG. 6(b) is a view showing an ON state of the Hall switch similar to that of FIG. 3(b).

FIG. 7 is a view showing a Hall element and a wiring circuit in the Hall switch according to the embodiment shown in FIG. 6.

### DETAILED DESCRIPTION

Now, the best modes for carrying out the present invention will be described with reference to the accompanying drawings.

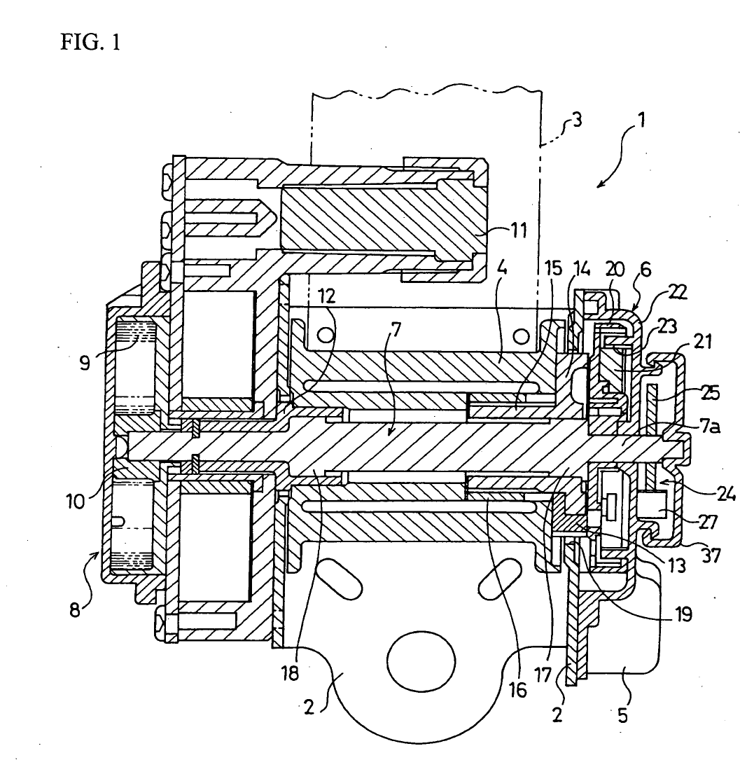

FIG. 1 is a longitudinal cross-sectional view showing a seat belt retractor according to an embodiment of the present invention.

As shown in FIG. 1, a construction of the seat belt retractor 1 according to an embodiment similar to a seat belt retractor disclosed in, for example, Japanese Unexamined Patent Application Publication No. 2001-58559 (hereinafter known as the '559 reference and hereby incorporated by reference in its entirety). The similar portions of the seat belt retractor disclosed in the '559 reference will be described in brief.

In FIG. 1, reference numeral 1 denotes a seat belt retractor. Reference numeral 2 denotes a U-shaped frame. Reference numeral 3 denotes a seat belt.

Reference numeral 4 denotes a spool which is rotatably supported between both side walls of the U-shaped frame 2 to retract the seat belt 3. Reference numeral 5 denotes a deceleration sensing unit which operates by sensing a large deceleration of a vehicle at a time of emergency. Reference numeral 6 denotes a lock member which is operated by a deceleration sensing unit 5 to prevent at least a rotation of the spool 4 in a belt withdrawn direction thereof.

Reference numeral 7 denotes a torsion bar which is inserted into a center of the spool 4 to axially pass through the spool with a play and rotatably connect the spool 4 and the lock member 6. Reference numeral 8 denotes a spring member which constantly urges the spool 4 in a belt retracted direction through a bushing 10 by an elastic force of the spiral spring 9. Reference numeral 11 denotes a pre-tensioner which operates at the time of an emergency to generate a belt retracting torque. Reference numeral 12 denotes a bushing for transmitting the seat belt retracting torque of the pre-tensioner 11 to the spool 4.

The lock member 6 includes a locking base 14 which can integrally rotate with a first torque transmission shaft 17 of the torsion bar 7 and which swingably supports a pawl 13 and a locking gear 20. The locking gear 20 is supported by a protrusion shaft 7a of the torsion bar 7 to rotate integrally with the torsion bar 7 in a normal state and to stop by an operation of the deceleration sensing unit 5 at the time of an emergency so as to rotate relative to the torsion bar 7. Here, at the time of an emergency, due to the relative rotation thereof, the pawl 13 is latched to an inner tooth 19 of a side wall of the frame 2 so that the rotation of the locking base 14 in the seat belt withdrawn direction is prevented. An external thread shaft portion 15 is formed in the locking base 14, and a nut-shaped stopper member 16 which rotates integrally with the spool 4 is engaged with the external thread shaft portion 15 in a screw-like manner. On the other hand, an inertia body 21 having a latch stopper is swingably supported to the lock gear 20. When the lock gear 20 rotates with an angular acceleration exceeding a predetermined value thereof in the belt withdrawn direction, the inertia body 21 is allowed to swing so that the latch stopper is latched to the inner tooth 23 formed in the cover 22 fixed to the frame 2.

In addition, the torsion bar 7 is provided with a first torque transmission portion 17 which is latched so as to prohibit a relative motion with respect to the locking base 14 and a second torque transmission portion 18 which is latched so as to prohibit a relative motion with respect to the spool 4.

In addition, because an elastic force of the spring member 8, the spool 4 is constantly urged in the seat belt retracted direction through the bushing 10, the torsion bar 7, the second torque transmission portion 18 of the torsion bar 7, and the bushing 12. In addition, when the pre-tensioner 11 operates, the belt retracting torque generated by the pre-tensioner 11 is transmitted through the bushing 12 to the spool 4 so that the spool 4 retracts the seat belt 3 by a predetermined amount.

In the seat belt retractor 1 having such a construction, the seat belt 3 is entirely retracted by an elastic urging force of the spring member 8 when the seat belt is not fastened. When the seat belt 3 is withdrawn in a normal speed in order to fasten the seat belt, the spool 4 rotates in the seat belt withdrawn direction so that the seat belt 3 is withdrawn smoothly. The tongue (not shown) slidably formed on the seat belt 3 is inserted into and engaged with the buckle (not shown) fixed to the chassis. Afterwards, the excessively withdrawn seat belt 3 is retracted to the spool 4 by the urging force of the spring member 8 so that the seat belt 3 is fitted to the occupant to an extent that the occupant does not feel constrained.

At the aforementioned time of an emergency, the seat belt retracting torque generated by the pre-tensioner 11 is transmitted to the spool 4, and the spool 4 retracts the seat belt 3 by a predetermined amount thereof to firmly restrain the occupant. On the other hand, the deceleration sensing unit 5 operates due to a large deceleration of the vehicle generated at the time of an emergency so that the lock member 6 operates. Namely, the rotation of the lock gear 20 in the seat belt withdrawn direction is prevented by the operation of the deceleration sensing unit 5 so that the pawl 13 of the lock member 6 rotates to be latched to an inner tooth 19 of a side wall of the frame 2. Accordingly, because a rotation of the locking base 14 in the seat belt withdrawn direction is prevented, the torsion bar 7 is distorted, and only the spool 4 rotates relative to the locking base 14 in the seat belt withdrawn direction. After that, the spool 4 distorts the torsion bar 7 and rotates in the seat belt withdrawn direction. A load exerted on the seat belt 3 is limited by a distortion torque of the torsion bar 7 so that an impact exerted on the occupant is absorbed and lessened.

The spool 4 relatively rotates with respect to the locking base 14 so that the stopper member 16 which rotates integrally with the spool 4 rotates relative to the external thread shaft portion 15 which is engaged in a screw-like manner to move toward the locking base 14. When the stopper member 16 is in contact with the locking base 14, a further rotation of the stopper member 16 is prevented so that the rotation of the spool 4 is also prevented and the distortion of the torsion bar 7 is stopped. Thus, the withdrawing of the seat belt 3 is prevented so that the occupant is securely restrained by the seat belt 3, and the maximum distortion of the torsion bar 7 is limited so that the disconnection of the torsion bar 7 caused from the distortion thereof is prevented.

At a time of rapidly retracting the seat belt 3, the lock gear 20 rotates with an angular acceleration exceeding a predetermined value thereof in the belt withdrawn direction so that an inertia body 21 is allowed to swing, and thus, the latch stopper is latched to the inner tooth 23. Therefore, the locking base 14 of the lock member 6 rotates relative to the lock gear 20 in the seat belt withdrawn direction so that the pawl 13 of the lock member 6 is latched to the inner tooth 19 of the side wall of the frame 2 as described above. Accordingly, because the rotation of the locking base 14 is prevented, the rotation of the spool 4 in the belt withdrawn direction is prevented by the torsion bar 7 so that the withdrawing of the seat belt is prevented.

Now, the improved portions of the seat belt retractor 1 according to an embodiment of the present invention will be described.

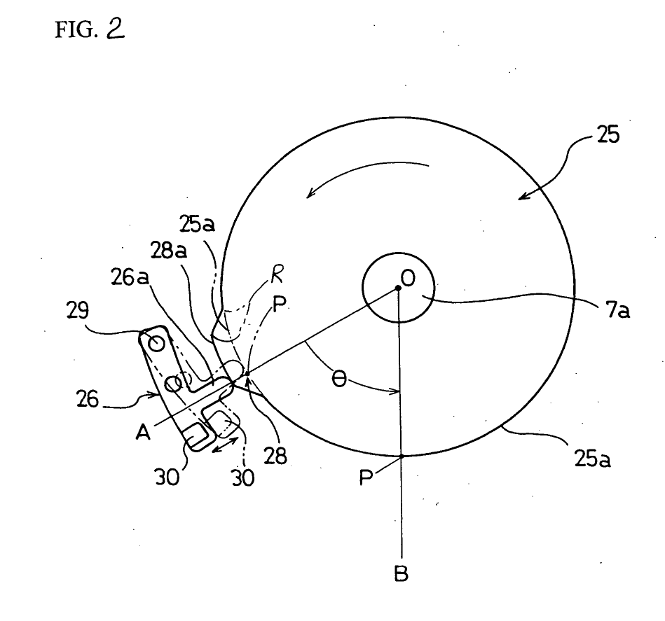

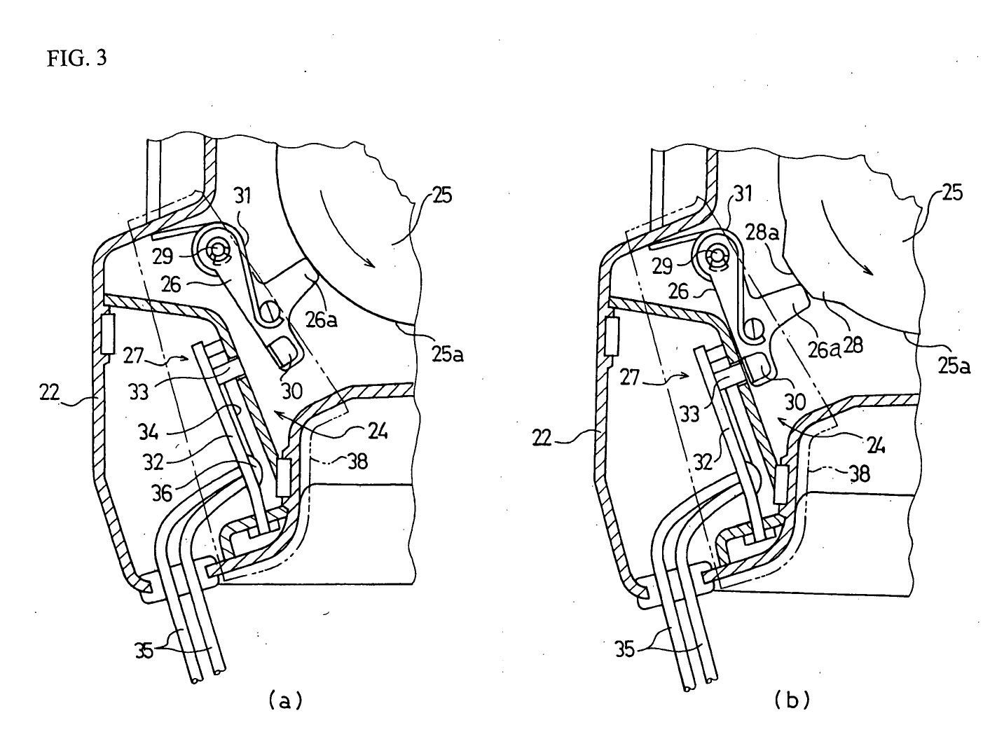

As shown in FIG. 1, the seat belt retractor 1 according to an embodiment or the present invention includes a rotation angle detecting unit 24 which is disposed on the side of a cover 22 to detect a rotation angle of the protrusion shaft 7a of the torsion bar 7. As shown in FIG. 2 and FIGS. 3(a) and 3(b), the rotation angle detecting unit 24 includes a rotation angle detecting cam wheel 25, a switch lever 26, and a Hall switch 27.

The rotation angle detecting cam wheel 25 is formed on the protrusion shaft 7a of the torsion bar 7 so as to rotate integrally therewith and detect a rotation displacement (rotation angle) of the protrusion shaft 7a. As shown in FIG. 2, the rotation angle detecting cam wheel 25 is formed in a shape of a disc, and a convex cam 28 is formed on a portion of a circumferential surface thereof. The circumferential surface 28a of the convex cam 28 is formed to be concentric with the rotation angle detecting cam wheel 25 and be in a shape of an arc having a predetermined arc length. In addition, both ends of the circumferential surface 28a are in contact with the circumferential surface 25a of the rotation angle detecting cam wheel 25 through slanted planes thereof. In this case, curved R portions are formed between the circumferential surface 28a of the convex cam 28 and the slanted plane and between the circumferential surface 25a of the rotation angle detecting cam wheel 25 and the slanted plane so as to form smoothly continuous surfaces.

The one end of the switch lever 26 is swingably supported by the cover 22 about a swing shaft 29, and a magnet 30 is attached to the other end thereof. In addition, a protrusion 26a is formed at a predetermined middle position in the switch lever 26 between the swing shaft 29 and the magnet 30 to extend in a direction substantially perpendicular to a straight line connecting the swing shaft 29 and the magnet 30. A distal end of the protrusion 26a has a curved surface. As shown in FIGS. 3(a) and 3(b), the switch lever 26 is constantly urged by a torsion spring 31 toward the rotation angle detecting cam wheel 25. As a result, the distal end of the protrusion 26a is always in contact with the entire circumferential surface of the rotation angle detecting cam wheel 25 including the circumferential surface 25a of the rotation angle detecting cam wheel 25, the circumferential surface 28a of the convex cam 28, the slanted planes therebetween, and R portions thereof. Accordingly, when the rotation angle detecting cam wheel 25 rotates, the switch lever 26 is controlled to swing along the shape of the entire circumferential surface of the rotation angle detecting cam wheel 25. At this time, because the smoothly continuous surfaces are formed between the circumferential surface 28a of the convex cam 28 and the slanted plane and between the circumferential surface 25a of the rotation angle detecting cam wheel 25 and the slanted plane and because the distal end of the protrusion 26a is formed to have a curved surface, the protrusion 26a can smoothly trace along the shape of the entire circumferential surface of the rotation angle detecting cam wheel 25.

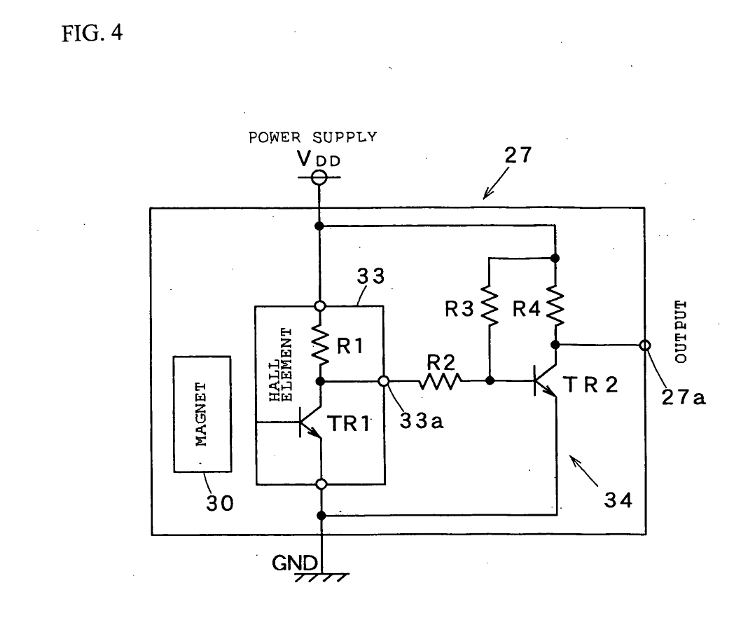

As shown in FIGS. 3(a) and 3(b), the Hall switch 27 includes the aforementioned magnet 30, a board 32 attached on the cover 22, a Hall element 33 attached on the board 32, and a wiring circuit 34 which is printed on the board 32 and electrically connected to the Hall element 33. As shown in FIG. 4, for example, the Hall element 33 is constructed with a resistor R1 and a transistor TR1, and the wiring circuit 34 is constructed with three resistors R2, R3, and R4 and a transistor TR1. When the magnet 30 is separated from the Hall element 33, the transistor TR1 is not in a conductive state so that a potential of an output portion 33a of the Hall element 33 becomes high. Accordingly, the transistor TR2 of the wiring circuit is in the conductive state so that a potential of an output portion 27a of the Hall switch 27 becomes low. Namely, the Hall switch 27 is in the off state. On the other hand, when the magnet 30 approaches the Hall element 33 as shown in FIG. 4, the transistor TR1 is in the conductive state so that the potential of the output portion 33a of the Hall element 33 becomes low. Accordingly, the transistor TR2 of the wiring circuit is not in the conductive state so that the potential of the output portion 27a of the Hall switch 27 becomes high. Namely, the Hall switch 27 is in the ON state.

The Hall element 33 and the wiring circuit 34 of the Hall switch 27 are not limited to those shown in FIG. 4. Any Hall element and wiring circuit may be used which allow the Hall switch 27 to be in the OFF state so as not to output when the magnet 30 is separated from the Hall element 33 and which allow the Hall switch 27 to be in the ON state so as to output when the magnet 30 approaches the Hall element 33.

The output portion 27a of the wiring circuit 34 for the Hall switch 27 is electrically connected to the wire harness 35 with a solder bump 36. The wire harness 35 is electrically connected to an electronic controller (not shown) of the seat belt device.

In addition, as shown in FIG. 3(a), when the distal end of the protrusion 26a of the switch lever 26 is in contact with the circumferential surface 25a of the rotation angle detecting cam wheel 25, the switch lever 16 is in a maximum rotation state in the counterclockwise direction in FIG. 3(a). In this state, because the magnet 30 is largely separated from the Hall element 33, the Hall element 33 is in the OFF state so that the Hall switch 27 is in the off state. On the other hand, as shown in FIG. 3(b), when the distal end of the protrusion 26a of the switch lever 26 is in contact with the circumferential surface 28a of the convex cam 28, the switch lever 26 is in a maximum rotation state in the clockwise direction in FIG. 3(b). In this state, because the magnet 30 closely approaches the Hall element 33, the Hall element 33 is in the ON state so that the Hall switch 27 is in the ON state.

The convex cam 28 is set to a position as follows. Namely, as shown in FIG. 2, the convex cam 28 is set to a position that the Hall element 33 is in the ON state by contacting the distal end of the protrusion 26a with the circumferential surface 28a of the convex cam 28 when a point P on the circumferential surface 25a of the rotation angle detecting cam wheel 25 (a point on the circumferential surface 25a indicated by a two-dotted dashed line of FIG. 2), which is positioned on a segment OA extending radially from a rotational center O of the rotation angle detecting cam wheel 25 when the seat belt 3 is not fastened and entirely retracted to the spool 4, rotates by a predetermined angle θ so as to be positioned on a vertical segment OB of FIG. 2.

The Hall switch 27 does not go into the ON state just after the seat belt 3 is retracted from the state where the seat belt is not fastened and entirely retracted to the spool 4, but the Hall switch 27 is set to be in the ON state when the seat belt 3 is retracted by a predetermined amount, that is, when the spool 4 rotates by a predetermined angle θ in the belt withdrawn direction. By doing so, it is possible to prevent the electronic controller (which simply determines that the seat belt 3 is fastened when the occupant withdraws the seat belt as much as a fastening-available amount) from erroneously determining that the seat belt 3 is fastened although the occupant does not withdraw the seat belt 3 by a fastening-available amount. Thus, the belt withdrawn amount sensing unit is constructed with the rotation angle detecting unit 24 including the Hall switch 27.

In FIG. 1, reference numeral 37 denotes a cover which is attached the cover 22 to cover the rotation angle detecting unit 24. In addition, as shown with two-dotted dashed lines in FIGS. 3(a) and 3(b), a magnetic field shield member 38 is formed on both covers 22 and 37 to cover the magnet 30 and the Hall element 33 so that the magnetic field shield member 38 can prevent the influence of an external magnetic field on the Hall switch 27. Instead of the magnetic field shield member 38, both covers 22 and 37 may be constructed with a magnetic field shield material.

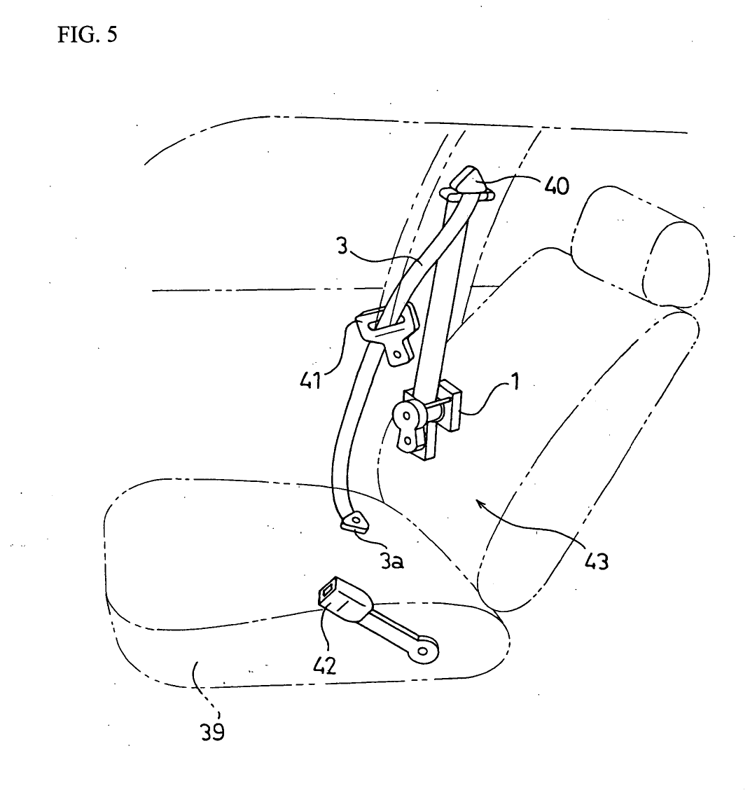

The seat belt retractor 1 according to the embodiment may be applied to a seat belt retractor used for a conventional well-known seat belt device. As an example of a seat belt device, as shown in FIG. 5, there is a seat belt device 43 including a seat belt retractor 1 fixed to a chassis, a seat belt 3 which is retracted from the seat belt retractor 1 and has a belt anchor 3a formed at an end thereof to be fixed to a bottom of the chassis or a vehicle seat 39, a guide anchor 40 for guiding the seat belt 3 withdrawn from the seat belt retractor 1 to a shoulder of an occupant, a tongue 41 which is slidably supported to the seat belt 3 guided by the guide anchor 40, and a buckle 42 which is fixed to the bottom of the chassis or the vehicle seat in which the tongue is to be inserted into and releaseably engaged with the buckle.

According to the seat belt retractor 1 according to this embodiment, because the Hall switch 27 is used for the rotation angle detecting unit 24, even in a case where the Hall switch 27 is stained with contaminants, it is possible to suppress influence of the contaminants on the detection of the rotation angle of the spool 4. Therefore, the rotation angle of the spool 4 can be sensed with a high accuracy in a long term use, and the reliability of the rotation angle detecting unit 24 can be improved.

In addition, the Hall switch 27 can allow a small current to flow in the OFF state where the magnet 30 does not approach. Therefore, by setting a small current, for example, 7 mA to flow in the OFF state and a relatively large current, for example, 20 mA to flow in the ON state, the withdrawn amount of the seat belt can be securely sensed, and electrical disconnection due to the disconnection of the wiring circuit 34 or the wire harness 35 or defects of the solder bump 36 at the OFF state can be securely detected. By doing so, the reliability of the belt withdrawn amount sensing can be further improved. In addition, because there is no need to use resistors unlike the aforementioned conventional case, it is possible to suppress the increase in the number of parts and to reduce costs.

In addition, because the rotation angle detecting unit 24 is used as a belt withdrawn amount detecting unit, it is possible to more securely detect the fastening of the seat belt by the occupant. In addition, because the rotation angle detecting unit 24 is attached to the seat belt retractor 1 fixed to the chassis, even in a case where it is applied to the aforementioned vehicle in which the vehicle seat 39 is detachable from the chassis, there is no need for a connection unit for the wire harness between the buckle and the chassis.

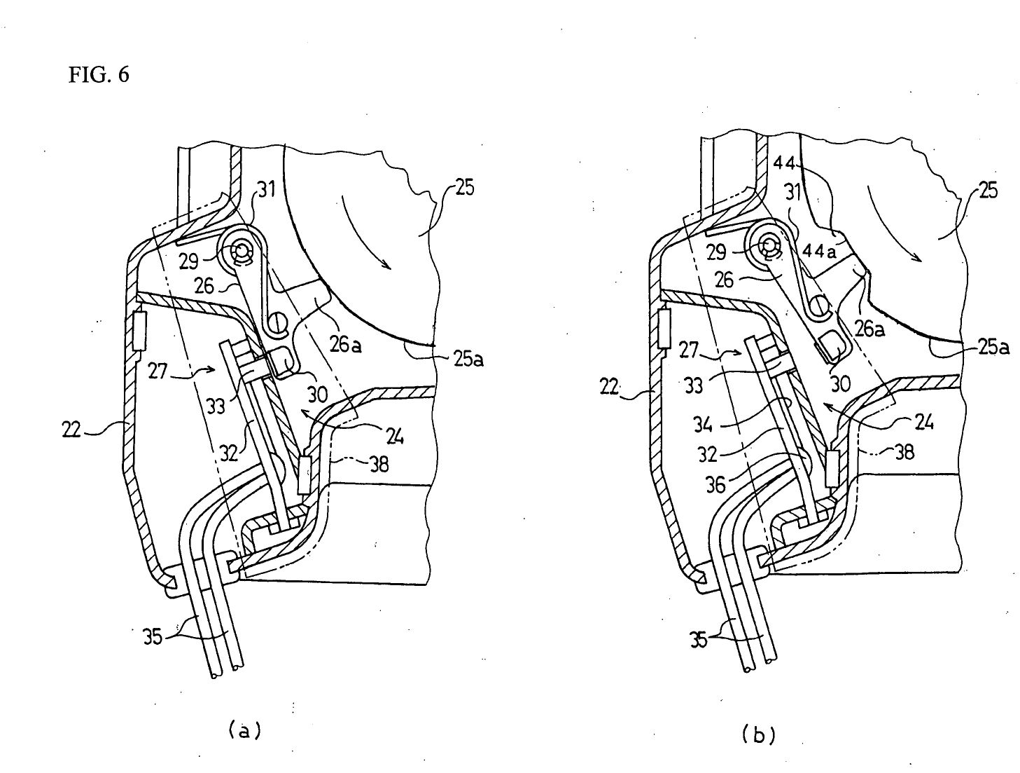

FIG. 6 is a view showing a seat belt retractor according to another embodiment of the present invention. FIG. 6(a) shows an OFF state of the Hall switch similar to that of FIG. 3(a). FIG. 6(b) shows an ON state of the Hall switch similar to that of FIG. 3(b). In addition, the same reference numerals denote the same elements as those of the aforementioned embodiment, and detailed description thereof is omitted.

In the embodiment of FIGS. 3(a) and 3(b), when the magnet 30 approaches the Hall switch 27, the Hall switch 27 is set to be in the ON state so as to sense the fastening of the seat belt. However, in the embodiment of FIGS. 6(a) and 6(b), when the magnet 30 is separated from the Hall switch 27, the Hall switch 27 is set to be in the ON state so as to sense the fastening of the seat belt.

As shown in FIGS. 6(a) and 6(b), in the belt withdrawn amount sensing unit according to the embodiment, instead of the convex cam 28 according to the embodiment of FIGS. 3(a) and 3(b), a concave cam 44 is formed in the rotation angle detecting cam wheel 25 in the same form as that of the convex cam 28.

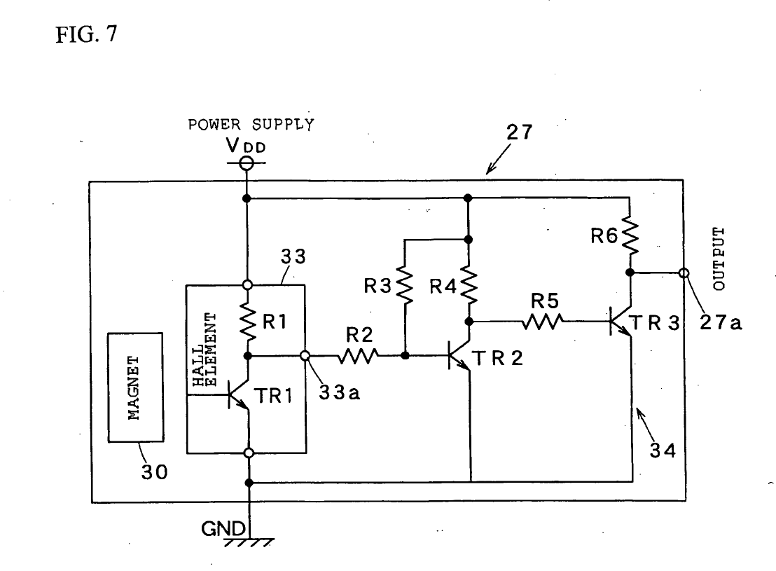

In addition, as shown in FIG. 7, the wiring circuit 34 of the Hall switch 27 according to the embodiment is constructed by additionally connecting two resistors R5 and R6 and a transistor TR3 to the output portion of the wiring circuit 34 according to the embodiment shown in FIG. 4. When the magnet 30 approaches the Hall element 33, a potential of the output portion 33a of the Hall element 33 is lowered in the manner similar to that according to the embodiment of FIG. 4 so that the transistor TR2 of the wiring circuit 34 is not in the conductive state. As a result, the transistor TR3 is in the conductive state so that a potential of the output portion 27a of the Hall switch 27 decreases. Namely, the Hall switch 27 is in the off state. On the other hand, when the magnet 30 is separated from the Hall element 33, the potential of the output portion 33a of the Hall element 33 is heightened, so that the transistor TR2 of the wiring circuit 34 is in the conductive state. As a result, the transistor TR3 is not in the conductive state so that the potential of the output portion 27a of the Hall switch 27 increases. Namely, the Hall switch 27 is in the ON state. Unlike the Hall switch 27 according to the embodiment of FIGS. 3(a) and 3(b), the Hall switch 27 according to the embodiment of FIGS. 6(a) and 6(b) is in the ON state when the magnet 30 is separated from the Hall element 33.

The Hall element 33 and the wiring circuit 34 of the Hall switch 27 are not limited to those shown in FIG. 7. Any Hall element and wiring circuit may be used which allow the Hall switch 27 to be in the OFF state so as not to produce output when the magnet 30 approaches the Hall element 33 and the Hall switch 27 to be in the ON state so as to produce output when the magnet 30 is separated from the Hall element 33.

In addition, as shown in FIG. 6(a), when the distal end of the protrusion 26a of the switch lever 26 is in contact with the circumferential surface 25a of the rotation angle detecting cam wheel 25, the switch lever 26 is in a maximum rotation state in the clockwise direction. In this state, because the magnet 30 closely approaches the Hall element 33, the Hall switch 27 is in the OFF state. On the other hand, as shown in FIG. 6(b), when the distal end of the protrusion 26a of the switch lever 26 is in contact with the circumferential surface 44a of the concave cam 44, the switch lever 26 is in a maximum rotation state in the counterclockwise direction. In this state, because the magnet 30 is largely separated from the Hall element 33, the Hall switch 27 is in the ON state.

Other constructions and operations of the seat belt retractor 1 according to the embodiment of FIGS. 6(a) and 6(b) are the same as those according to the embodiment of FIGS. 3(a) and 3(b), and advantages of the seat belt retractor 1 according to the embodiment of FIGS. 6(a) and 6(b) are the same as those according to the embodiment of FIGS. 3(a) and 3(b).

In addition, the seat belt retractor 1 according to the present invention is not limited to the embodiment shown in FIG. 1. Any seat belt retractor having at least a spool for withdrawably retracting a seat belt may be used.

A seat belt retractor and a seat belt device according to the present invention can be preferably used as a seat belt retractor having a belt fastening sensing unit for sensing a withdrawn amount of a seat belt to sense a seat belt fastened state of an occupant and can be a seat belt device having the seat belt retractor.

The priority applications, Japanese Patent Application No. 2005-190973, filed on Jun. 30, 2005, and Japanese Patent Application No. 2006-050419, filed Feb. 27, 2006, including the specifications, drawings, claims and abstracts, are incorporated herein by reference in their entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A seat belt retractor comprising:
a spool for withdrawably retracting a seat belt, and
a rotation angle detecting unit for detecting a rotation angle of the spool,
wherein the rotation angle detecting unit includes a belt withdrawn amount sensing unit for detecting a predetermined rotation angle of the spool in a belt withdrawn direction, and
wherein the belt withdrawn amount sensing unit comprises a Hall switch which includes a magnet for moving according to a predetermined rotation amount of the spool in the belt withdrawn direction of the spool and a Hall element which is controlled to be turned on or off by the magnet.

2. The seat belt retractor according to claim 1, further comprising a switch lever comprising one end portion that is swingably supported by a frame which rotatably supports the spool or that is swingably supported by a fixing member to which the frame is fixed, and
wherein the magnet is attached to the other end portion of the switch lever.

3. The seat belt retractor according to claim 2, wherein the switch lever is formed to rotate with the spool and controlled to swing by a rotation angle detecting cam wheel having a convex cam on a circumference thereof, so that, when the spool is in an entire retracted state, the switch lever allows the magnet to be at a specified distance away from the Hall element so as to turn off the Hall switch.

4. The seat belt retractor according to claim 3, wherein, at a time when the seat belt is withdrawn by a predetermined withdrawn amount with reference to the entire retracted state of the spool, the convex cam allows the switch lever to operate and the magnet to be closer than the specified distance to the Hall element to turn on the Hall switch.

5. The seat belt retractor according to claim 2, wherein the switch lever is formed to rotate with the spool and controlled to swing by a rotation angle detecting cam wheel having a concave cam on a circumference thereof, so that, when the spool is in an entire retracted state, the switch lever allows the magnet to be at a specified distance away from the Hall element to turn off the Hall switch.

6. The seat belt retractor according to claim 5, wherein, at a time when the seat belt is withdrawn by a predetermined withdrawn amount with reference to the entire retracted state of the spool, the concave cam allows the switch lever to operate and the magnet to be farther from the specified distance to the Hall element so as to turn on the Hall switch.

7. A seat belt device comprising:
a seat belt
a seat belt retractor for retracting a seat belt;
a tongue slidably supported by the seat belt withdrawn from the seat belt retractor; and
a buckle for releaseably engaging the tongue,
wherein the seat belt retractor comprises:
a spool for withdrawably retracting a seat belt, and
a rotation angle detecting unit for detecting a predetermined rotation angle of the spool in a belt withdrawn direction,
wherein the rotation angle detecting unit comprises a Hall switch which includes a magnet configured to move according to a predetermined rotation amount of the spool in the belt withdrawn direction of the spool and a Hall element which is controlled to be turned on or off by the magnet.

8. A seat belt retractor comprising:
a spool for withdrawably retracting a seat belt, and
a Hall switch for detecting a predetermined rotation angle of the spool in a belt withdrawn direction, wherein the switch includes a magnet configured to move an amount corresponding to a predetermined rotation amount of the spool in the belt withdrawn direction of the spool and a Hall element which is configured to be placed in an on or off condition by the magnet.
